(19) United States
(12) Patent Application Publication
(10) Pub. No.: US 2017/0088440 A1
(43) Pub. Date: Mar. 30, 2017

(54) ULTRAVIOLET WATER PURIFIER

(71) Applicants: Chih-Yuan Chen, New Taipei City (TW); Shu-Hsi Lin, (US)

(72) Inventor: Shu-Hsi Lin, Taipei (TW)

(21) Appl. No.: 14/866,967

(22) Filed: Sep. 27, 2015

(51) Int. Cl. C02F 1/32; C02F 1/28

(52) U.S. Cl. CPC C02F 1/325; C02F 1/288; C02F 2201/32; C02F 2307/06

(57) ABSTRACT

An ultraviolet water purifier includes a water filter including a water inlet connector for guiding in a fluid, a filter element for filtering the fluid from the water inlet connector and a filtered water outlet connector for guiding out the filtered fluid, a housing including an intake water connection portion for guiding in the filtered fluid, a purified water output portion and a water passage in communication between the intake water connection portion and the purified water output portion, a hydroelectric generator drivable by the flowing of the filtered fluid in the water passage to generate electricity and to provide generated electricity to a germicidal UV lamp for sterilizing the filtered fluid that flows out of the water passage through the purified water output portion.

### BACKGROUND OF THE INVENTION

(a) Field of the Invention

The present invention relates to water purification technology and more particularly to a self-powered ultraviolet water purifier.

(b) Description of the Prior Art

Due to industrial and technological development, water pollution has become a major global problem today. The rise in health consciousness among people enforces requirements for drinking water quality. Thus, various water purifiers have been created and have appeared on the market. Commercial water purifiers use different water purification methods to remove pollutants, chloride and other impurities. The current water purification methods include reverse osmosis (RO) treatment, activated carbon filtration, water softening process of water, and distillation.

However, the aforesaid conventional water purification methods simply consider the factors of chemical pollutants and impurities, while ignoring microbial contamination in the transportation process. In consequence, ultraviolet water purification is developed. Commercial ultraviolet water purifiers have the drawbacks of inconvenience in use and power consumption because they need to consume battery or city power supply for driving a UV lamp to emit germicidal UV light. Some designs need to be used with a power generating mechanism. Further, these conventional ultraviolet water purifiers require much installation space, thus limiting the range of applications.

### SUMMARY OF THE INVENTION

The present invention has been accomplished under the circumstances in view. It is one object of the present invention to provide an ultraviolet water purifier that is self-powered and space-saving and provides an ultraviolet sterilization function.

It is another object of the present invention to provide an ultraviolet water purifier that is equipped with a filter element and provides a magnetization function.

To achieve these and other objects of the present invention, an ultraviolet water purifier comprises a housing, a hydroelectric generator, and a germicidal UV lamp. The housing comprises an intake water connection portion, a purified water output portion and a water passage in communication between the intake water connection portion and the purified water output portion. The intake water connection portion is adapted for guiding a fluid into the water passage. The purified water output portion is adapted for guiding the fluid out of the water passage. The hydroelectric generator is mounted in the water passage of the housing and drivable by the flowing of the fluid in the water passage to generate electricity for output through at least one electric current output terminal thereof. The germicidal UV lamp is mounted in the housing and electrically connected to the at least one electric current output terminal of the hydroelectric generator and adapted for emitting an ultraviolet light toward the water passage to sterilize the fluid for enabling the sterilized fluid to be guided out of the water passage through the purified water output portion.

According to the technical measures adopted by the present invention, the ultraviolet water purifier has all mechanisms arranged together without an external power source, thereby saving the installation space. When a fluid flows through the ultraviolet water purifier, chemical substances are removed by the filter element through multi-layer filtering, and at the same time, the hydroelectric generator converts kinetic energy into electrical energy for driving the germicidal UV lamp to sterilize the flow of fluid and the indicator light to give a visual indication signal, and thus, the user can use the highly purified and sterilized fluid safely.

### BRIEF DESCRIPTION OF THE DRAWINGS

FIG. 1 is an oblique top elevational view of an ultraviolet water purifier in accordance with the present invention.

FIG. 2 is a schematic side view of the ultraviolet water purifier in accordance with the present invention.

FIG. 3 is a perspective view illustrating the arrangement of component parts in the housing of the ultraviolet water purifier in accordance with the present invention.

FIG. 4 is a sectional view of a part of the ultraviolet water purifier in accordance with the present invention.

FIG. 5A-5C illustrates various adapters for selective use with the ultraviolet water purifier in accordance with the present invention.

FIG. 6 is a schematic view illustrating the ultraviolet water purifier in accordance with the present invention while connected to a water tap.

### DETAILED DESCRIPTION OF THE PREFERRED EMBODIMENTS

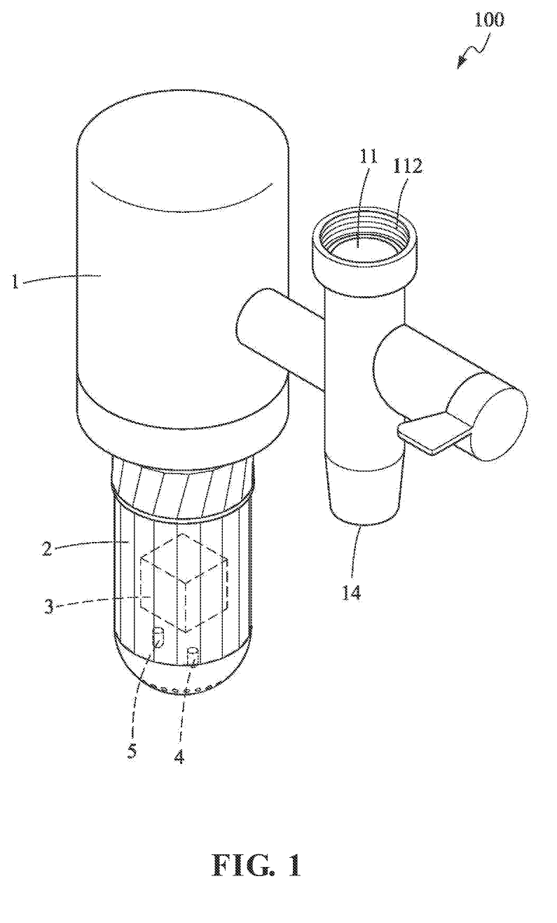

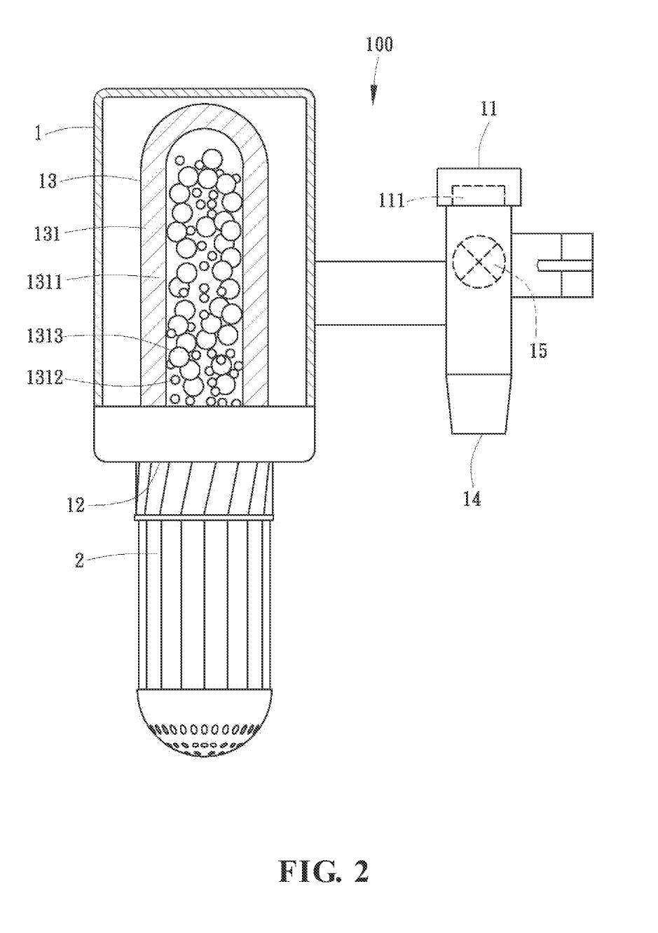

Referring to FIGS. 1 and 2, an ultraviolet water purifier 100 in accordance with the present invention is shown. The ultraviolet water purifier 100 comprises a water filter 1, which comprises a water inlet connector 11 adapted for connecting to a water source for taking in a fluid (water), a filtered water outlet connector 12 for letting out the fluid and a filter element 13 connected between the water inlet connector 11 and the filtered water outlet connector 12 for filtering the fluid passing from the water inlet connector 11 to the filtered water outlet connector 12, a housing 2, which comprises a water passage 23, an intake water connection portion 21 adapted for connecting to a water source for taking in a fluid and guiding the intake fluid into the water passage 23 and a purified water output portion 22 disposed in communication with one side of the water passage 23 opposite to the intake water connection portion 21 and adapted for guiding the fluid out of the water passage 23, a hydroelectric generator 3 mounted in the water passage 23 of the housing 2 and drivable by the fluid passing through the water passage 23 to generate electricity and to output electricity through at least one electric current output terminals 31a;31b thereof, and a germicidal UV lamp 4 mounted in the housing 2 and electrically connected to one electric current output terminal 31a of the hydroelectric generator 3 for emitting UV light toward the inside of the water passage 23 to sterilize the fluid passing through the water passage, enabling the sterilized fluid to pass out of the housing 2 through the purified water output portion 22.

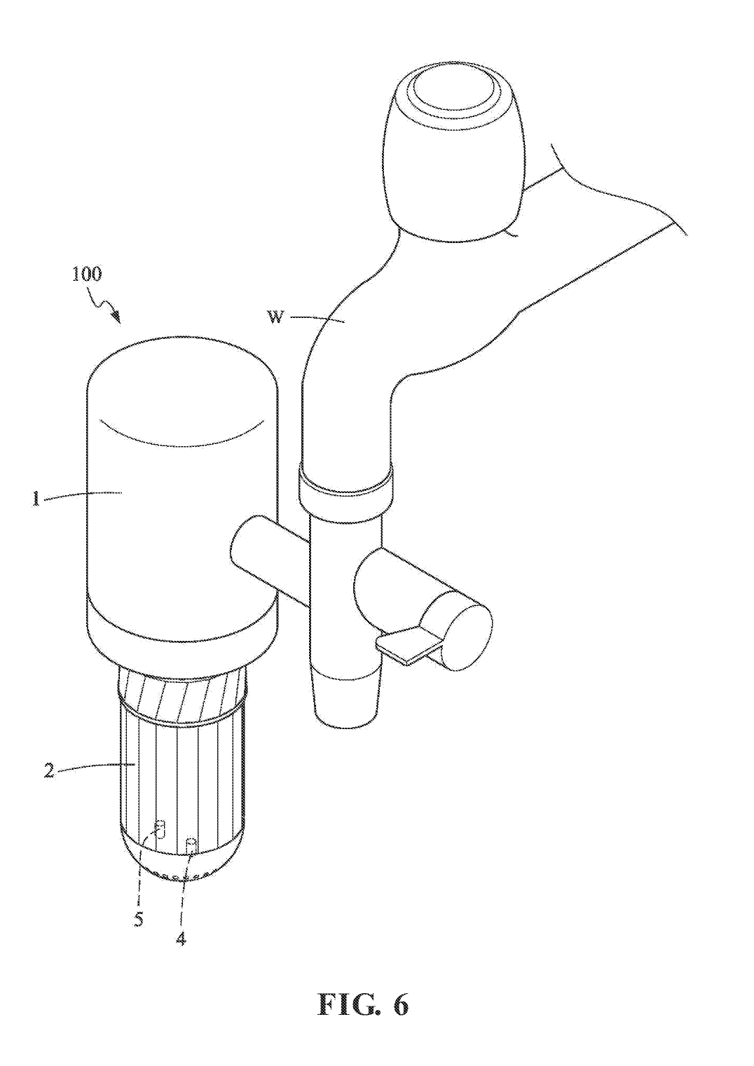

As illustrated in FIG. 1 and FIG. 2, the water inlet connector 11 of the water filter 1 is connected to a water source for taking in a fluid. In this embodiment, the water inlet connector 11 comprises an internally threaded connection portion 112 for connection to a water outlet device of a water source, for example, a water tap W (see FIG. 6). Alternatively, the water inlet connector 11 can be configured for connection to a water outlet mechanism of a water source using a socket connection or any other connection design. Further, the water outlet mechanism can be of any other design for letting out a fluid. The water filter 1 further comprises a tap water outlet device 14 and a water valve 15. The water inlet connector 11 is a three-way pipe joint, having one end thereof for fluid input and the other two ends thereof respectively connected to the tap water outlet device 14 and the filter element 13 to provide the intake flow of fluid to the tap water outlet device 14 and the filter element 13. The water valve 15 is mounted in the water inlet connector 11 between the filter element 13 and the tap water outlet device 14 and controllable to let the intake flow of fluid go from the fluid inlet end of the water inlet connector 11 into the filter element 13 or the tap water outlet device 14. The water valve 15 is rotatably switchable between a first switch position and a second switch position. When the water valve 15 is switched to the first switch position, the passage between the water inlet connector 11 and the tap water outlet device 14 is turned off and the passage between the water inlet connector 11 and the filter element 13 is turned on, enabling the intake flow of fluid to go from the water inlet connector 11 into the filter element 13. The filter element 13 comprises a core member 131 that is mounted inside the filter element 13. The core member 131 comprises a ceramic micro porous outer shell 1311, a plurality of spherical metal clusters 1312, and a plurality of activated carbon spheres 1313, The spherical metal clusters 1312 and the activated carbon spheres 1313 are mounted in the ceramic micro porous outer shell 1311 for filtering the fluid passing through the filter element 13, enabling the filtered fluid to flow out of the filtered water outlet connector 12. When the water valve 15 is switched to the second switch position, the water valve 15 stops the passage between the water inlet connector 11 and the filter element 13 and opens the passage between the water inlet connector 11 and the tap water outlet device 14, letting the intake flow of fluid go from the water inlet connector 11 into the tap water outlet device 14. The tap water outlet device 14 has a plurality of water outlet holes located in a downstream thereof for letting out tap water.

In this embodiment, as shown in FIG. 2, the water inlet connector 11 comprises therein a magnetized portion 111. The magnetized portion 111 is disposed inside the water inlet connector 11 in an upstream area relative to the filter element 13 and the tap water outlet device 14 for magnetizing the fluid passing through the water inlet connector 11. The magnetized portion 111 can be a magnetized metal ring. When a fluid is flowing through the magnetic field generated by the magnetized metal ring, the fluid molecules are broken into micro-clusters or single water molecules.

More specifically, the structure of the housing 2 is as shown in FIGS. 2-4. The intake water connection portion 21 of the housing 2 is connected to the filtered water outlet connector 12 for taking in the fluid filtered through the filter element 13. In this embodiment, the intake water connection portion 21 of the housing 2 is threaded onto the filtered water outlet connector 12 of the water filter 1. Alternatively, the intake water connection portion 21 can be connected to the filtered water outlet connector 12 by any other connection design, or, the housing 2 can be connected to any other water filter, water tap or water outlet device for sterilizing a fluid using ultraviolet light. The intake water connection portion 21 guides the fluid from the filtered water outlet connector 12 into the water passage 23. When the intake flow of fluid goes through the water passage 23, it flows over the hydroelectric generator 3 in the water passage 23 toward the purified water output portion 22. The purifired water output portion 22 has a plurality of water outlet holes in a bottom side thereof for fluid output for application.

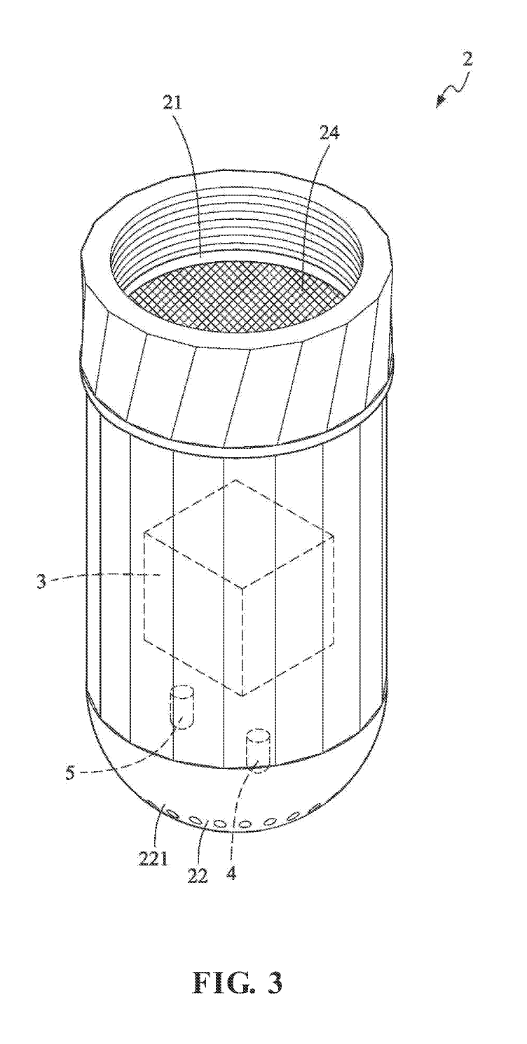

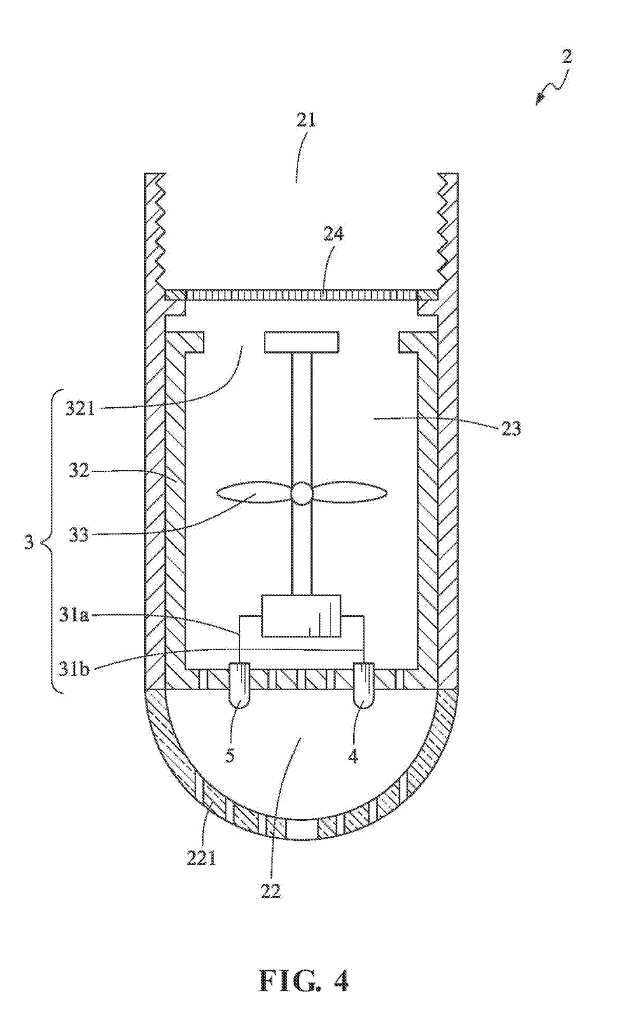

As illustrated in FIG. 3 and FIG. 4, the housing 2 further comprises a filter gauze 24 mounted in the water passage 23 in an upstream of the hydroelectric generator 3. In this embodiment, the filter gauze 24 is fastened to the housing 2 by snap connection. However, the connection is not limited to this connection method. Alternatively, the filter gauze 24 may be fastened to the housing 2 using a socket connection or any other connection design. The filter gauze 24 is adapted for removing impurities from the fluid, preventing impurities from causing the hydroelectric generator 3 to malfunction.

As illustrated in FIG. 3 and FIG. 4, the hydroelectric generator 3 is mounted in the water passage 23, comprising a body shell 32 and a blade propeller 33 rotatably mounted in the body shell 32. The body shell 32 comprises a fluid inlet component 321. In this embodiment, the fluid inlet component 321 has a plurality of fluid inlet holes. The fluid inlet component 321 has one side thereof facing toward the blade propeller 33, and an opposite side thereof facing toward the intake water connection portion 21 and disposed in communication with the water passage 23. When the fluid in the water passage 23 flows into the fluid inlet component 321, the flowing of the fluid drives the blade propeller 33 to rotate, converting kinetic energy into electrical energy due to electromagnetic effect and outputting converted electrical energy through the electric current output terminals 31a;31b. In this embodiment, the hydroelectric generator 3 is a high power electromagnetic device drivable by a low pressure flow of fluid to generate electricity.

As illustrated in FIG. 3 and FIG. 4, the germicidal UV lamp 4 is mounted in the housing 2 inside the body shell 32 of the hydroelectric generator 3 and electrically connected to one electric current output terminal 31a of the hydroelectric generator 3 for receiving electricity therefrom and emitting ultraviolet light toward the inside of the water passage 23 to sterilize the fluid passing by. In this embodiment, the germicidal UV lamp 4 is a deep UV LED of wavelength in the range of 100-280 nm that is more destructive to nucleic acid and protein of microorganisms than traditional UV lamps. However, this wavelength range is not a limitation. Any UV lamp in other wavelength ranges can be selectively used. As illustrated in FIG. 4, the ultraviolet water purifier 100 further comprises an indicator light 5 mounted inside the water passage 23 and inserted into the body shell 32 and electrically connected to the electric current output terminal 31b of the hydroelectric generator 3. The indicator light 5 is driven by the electricity outputted through the electric current output terminal 31b to give off a visual indication light when the germicidal UV lamp 4 is turned on to emit ultraviolet light, indicating the light-emitting operation of the germicidal UV lamp 4. Further, as illustrated in FIG. 2, the purified water output portion 22 of the housing 2 has a light transmissive area 221 facing toward the indicator light 5 for letting light pass.

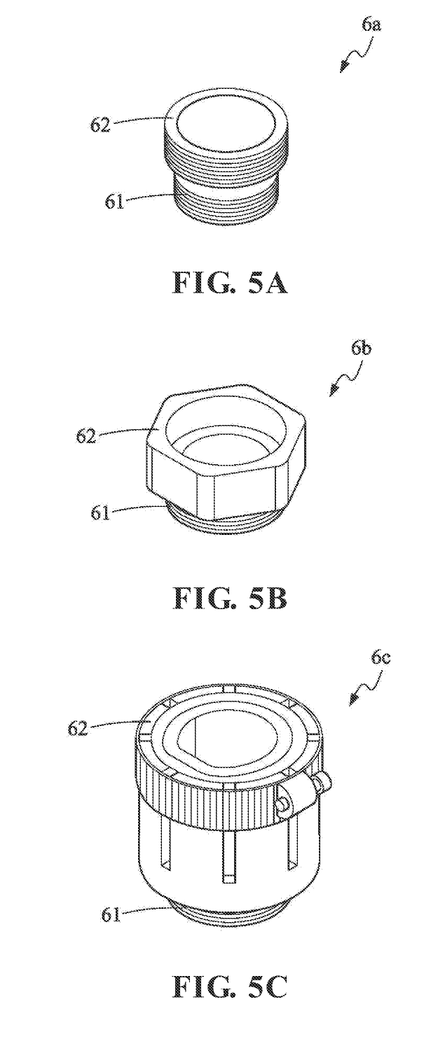

As illustrated in FIG. 6, the internally threaded connection portion 112 of the water inlet connector 11 of the water filter 1 can be threaded onto the outer thread of a water outlet device (water tap) W without an adapter. In order for the internally threaded connection portion 112 to fit any of a variety of other water outlet devices, such as internally threaded water tap, external 4-40 thread type water tap, conventional water faucet, etc., the ultraviolet water purifier 100 further comprises an adapter 6a,6b,6c (see FIG. 5). The adapter 6a,6b,6c comprises a water filter connection portion 61 located at one end thereof and an adapter connection portion 62 located at an opposite end thereof. The water filter connection portion 61 is connected to the water inlet connector 11 of the water filter 1. The adapter connection portion 62 is configured for connection to a mating external water outlet device (internally threaded water tap, four quarters exceptionally threaded water tap, or conventional water faucet). The adapter 6a shown in FIG. 5A is configured for connection to an internally threaded water tap; the adapter 6b shown in FIG. 5B is configured for connection to a four quarters exceptionally outer threaded water tap; the adapter 6c shown in FIG. 5C is configured for connection to a conventional water faucet.

The ultraviolet water purifier of the invention has multiple mechanisms integrated therein, eliminating an external power and saving the installation space. When a fluid flows through the ultraviolet water purifier, chemical substances are removed by the filter element through multi-layer filtering, and at the same time, the hydroelectric generator converts kinetic energy into electrical energy for driving the germicidal UV lamp to sterilize the flowing fluid and the indicator light to give a visual indication signal, and thus, the user can use the highly purified and sterilized fluid safely.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An ultraviolet water purifier, comprising:
a housing comprising an intake water connection portion, a purified water output portion and a water passage in communication between said intake water connection portion and said purified water output portion, said intake water connection portion being adapted for guiding a fluid into said water passage, said purified water output portion being adapted for guiding said fluid out of said water passage;
a hydroelectric generator mounted in said water passage of said housing and drivable by the flowing of said fluid in said water passage to generate electricity for output through at least one electric current output terminal thereof; and
a germicidal UV lamp mounted in said housing and electrically connected to said at least one electric current output terminal of said hydroelectric generator and adapted for emitting an ultraviolet light toward said water passage to sterilize said fluid while said fluid is being guided out of said flow passage through said purified water output portion.

2. The ultraviolet water purifier as claimed in claim 1, further comprising a water filter, said water filter comprising a water inlet connector adapted for connection to a water source to guide in said fluid, a filtered water outlet connector adapted for guiding out said fluid and a filter element set between said water inlet connector and said filtered water outlet connector for filtering said fluid that flows from said water inlet connector to said filtered water outlet connector, wherein said intake water connection portion of said housing is adapted for guiding said fluid from said filtered water outlet connector into said water passage.

3. The ultraviolet water purifier as claimed in claim 2, wherein said filter element comprises a core member mounted therein, said core member comprising a ceramic micro porous outer shell, a plurality of spherical metal clusters and a plurality of activated carbon spheres, said spherical metal clusters and said activated carbon spheres being mounted in said ceramic micro porous outer shell for filtering said fluid that flows through said filter element and out of said filtered water outlet connector.

4. The ultraviolet water purifier as claimed in claim 2, wherein said water inlet connector comprises a magnetized portion disposed inside said water inlet connector at an upstream location relative to said filter element for magnetizing said fluid that flows through said water inlet connector.

5. The ultraviolet water purifier as claimed in claim 2, wherein said hydroelectric generator comprises a body shell and a blade propeller rotatably mounted in said body shell, said body shell comprising a fluid inlet component disposed in communication with said water passage, said fluid inlet component having one side thereof facing toward said blade propeller and an opposite side thereof facing toward said intake water connection portion, said blade propeller being rotatably by said fluid passing through said fluid inlet component to cause generation of electricity.

6. The ultraviolet water purifier as claimed in claim 2, further comprising an indicator light mounted in said water passage and electrically connected to one said electric current output terminal of said hydroelectric generator for receiving electricity outputted through said electric current output terminal and giving off a visual indication signal upon operation of said germicidal UV lamp.

7. The ultraviolet water purifier as claimed in claim 6, wherein said purified water output portion comprises a light transmissive area facing toward said indicator light for the passing of said visual indication signal.

8. The ultraviolet water purifier as claimed in claim 2, wherein the wavelength of said germicidal UV lamp is in the range of 100˜280 nm.

9. The ultraviolet water purifier as claimed in claim 2, wherein said water inlet connector comprises an internally threaded connection portion for connection to an external water outlet device.

10. The ultraviolet water purifier as claimed in claim 2, further comprising an adapter, said adapter comprising a water filter connection portion connected to said water inlet connector of said water filter and an adapter connection portion adapted for connecting to a mating external water outlet device.
